(19) United States
(12) Patent Application Publication
(10) Pub. No.: US 2022/0405661 A1
(43) Pub. Date: Dec. 22, 2022

(54) Integrated System and Related Methods for Learning, Collaboration, Tournament Hosting, and Business Management

(71) Applicant: Roslena Dell Johnson, Cedar Hill, TX (US)

(72) Inventor: Roslena Dell Johnson, Cedar Hill, TX (US)

(21) Appl. No.: 17/350,456

(22) Filed: Jun. 17, 2021

(51) Int. Cl. G06Q 10/06; G09B 5/06; G10L 15/00; G10L 15/26; G10L 15/18

(52) U.S. Cl. CPC G06Q 10/0637; G06Q 10/067; G09B 5/065; G10L 15/005; G10L 15/26; G10L 15/18; G09B 5/067

(57) ABSTRACT

The present disclosure provides a system for hosting an online platform with multiple functionalities, separated into a plurality of interfaces, but all hosted within an integrated system to increase the immersion of a user in the learning experience. Multimedia content streaming, educational course, history, and tracking, and business management functions are provided on the various interfaces that quickly educate a user about a given industry. The platform is industry agnostic but can also be provided with specific functionalities such as competitive tournament hosting for the e-sports industry. Also provided herein is a method of translating an educational lecture from a first language into a plurality of second languages.

### FIELD OF INVENTION

The present invention relates generally to remote learning and entertainment. More specifically, the present invention relates to a system for hosting an integrated online learning and entertainment platform.

### BACKGROUND

As modern-day technology and social infrastructure continues to evolve, entirely new industries of professionals have emerged and continue to do so. Many of these industries are operated almost entirely online, making it difficult to provide the type of integrated learning/mentoring experience that young professionals generally need when entering a profession. Young professionals recognize the unlimited entrepreneurial opportunities available to them when they successfully achieve an integrated social media life that is enhanced with business and industry expertise. However, these online industries are complex and constantly changing—without an introduction to understanding industry fundamentals, young professionals and business start-ups are more likely to fail.

The field of e-sports is an example of a fast-growing new industry, commanding significant viewership and large commercial interests. Many competitive modern games offer multiplayer experiences where opposing teams compete and progress in a tournament style format, however merely being proficient at the games played is no longer enough for a professional player. They must also understand how to network, what their role is within the industry, and must have at least some understanding of business management and other elements such as website design and social branding.

Given that these industries are implemented online, it would be desirable for an integrated online learning experience to be provided on a platform which could also assist professionals with other industry activity such as collaboration, business management, and competitive play. It is within this context that the present invention is provided.

### SUMMARY

The present disclosure provides a system for hosting an online platform with multiple functionalities, separated into a plurality of interfaces, but all hosted within an integrated system to increase the immersion of a user in the learning experience. Multimedia content streaming, educational course, history, and tracking, and business management functions are provided on the various interfaces that quickly educate a user about a given industry. The platform is industry agnostic but can also be provided with specific functionalities such as competitive tournament hosting for the e-sports industry. Also provided herein is a method of translating an educational lecture from a first language into a plurality of second languages.

Thus, according to one aspect of the present disclosure there is provided an integrated system for learning, collaboration, tournament hosting, and business management, the system comprising: one or more client devices configured for communication over a network architecture and configured to store and view received data via one or more interfaces; one or more database having stored thereon learning content comprising multimedia data and e-learning course modules, and user data for a plurality of user profiles, the user data comprising an e-learning history for each user profile.

The system further comprises one or more servers in communication with the one or more databases and the one or more client devices, the one or more servers being configured to host an integrated learning, collaboration, tournament hosting, and business management platform comprising a set of interfaces for each function, each interface having one or more options for streaming or downloading multimedia data from the one or more databases, facilitating competitive online play between one or more user profiles, or providing an instant messaging and notification service between one or more user profiles.

In some embodiments, the platform interface for learning comprises options allowing a user to stream or download an audio or video file of an educational lecture.

The one or more servers may be further configured to implement a natural language processing algorithm to convert speech data from an audio or video file from the one or more databases into multiple languages, the algorithm comprising the steps of: receiving audio data comprising speech content in a first language; analysing and processing the audio data to generate a text transcript of the speech content in the first language; translate the text transcript of the speech content in the first language into text transcripts in one or more second languages; send the one or more translated text transcripts to a validating entity; receive one or more validated translated text transcripts from the validating entity; for each validated translated text transcript, analyse and process the transcript to generate output audio data comprising speech content in the second language of the translated transcript.

Furthermore, the one or more servers may be configured to overlay the audio data over a virtual lecture animation and stream the audio data and animation to the one or more client devices as an educational video.

In some embodiments, the platform interface for learning comprises options allowing a user to track their educational progress by accessing a learning history for their user profile from the one or more databases and viewing a course status for relevant courses.

In some embodiments, the platform interface for learning comprises options allowing a user to progress and track their educational progress by submitting and viewing the status of one or more assignments.

In some embodiments, the platform interface for learning comprises options allowing a user to track their educational progress by viewing one or more transcripts or certificates earned for a respective educational course.

In some embodiments, the platform interface for collaboration comprises options allowing a user to create private groups with one or more other uses, facilitating sending and receiving instant messages and media content within the group.

In some embodiments, the platform interface for business management comprises options allowing a user to create and design a website.

Additionally, the business management interface may further comprises options for uploading a brand logo.

Alternatively or additionally, the business management interface may comprise options for selecting a website them from one or more pre-built website themes stored on the one or more databases.

In some embodiments, the platform interface for tournament hosting comprises options allowing a user to create competitive gaming tournaments between one or more user profiles.

The tournament creation option may require a user to specify a tournament organizer, prize, and rule set for the competition.

In some embodiments, the tournament hosting interface comprises options allowing a user to register for participation in a tournament on the platform.

In some embodiments, the tournament hosting interface comprises options allowing a user to manage their match schedule for one or more tournaments on the platform by accessing tournament data associated with the user profile which is stored on the one or more databases.

### BRIEF DESCRIPTION OF THE DRAWINGS

Various embodiments of the invention are disclosed in the following detailed description and accompanying drawings.

FIG.1 illustrates a functional diagram of an example network architecture configuration of the disclosed system.

FIG.2 illustrates an example set of interface which a user logged in to a user profile may have access to within the disclosed system.

FIG.3 illustrates a flow diagram of an example method for translating speech content into multiple languages for streaming to users of the disclosed system.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present disclosure provides an integrated education and entertainment platform which allows users to learn and manage a self-encapsulated business organization in a given industry. Example businesses that may be learned and implemented via the disclosed system include but are not limited to: E-sports organizations, lifestyle branding companies, and multi-media entertainment companies.

The examples used herein will be limited to a single type of industry for clarity, the E-sports gaming industry, but a skilled person reading the present disclosure will understand that the methods and systems presented herein may be applied to a multitude of present and future industries. It is industry agnostic.

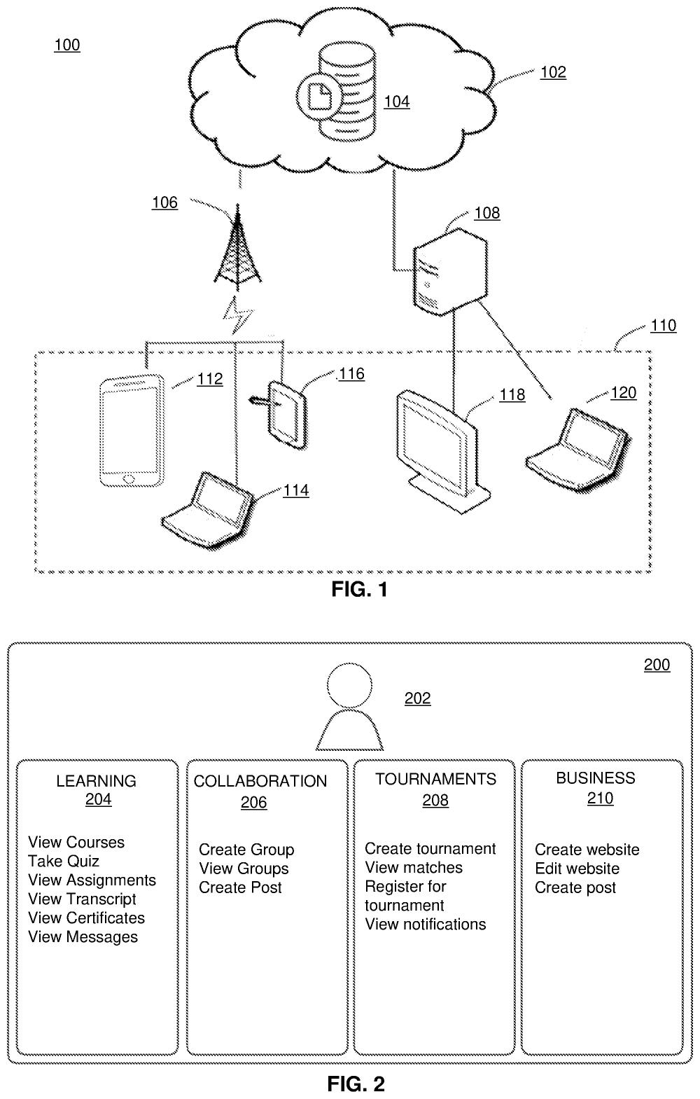

Referring to FIG.1 an example network architecture 100 is shown over which multimedia content and user data for wired and wireless implementations of the disclosed system can be stored, transmitted, and consumed.

One or more of the operations and calculations described herein may be performed by a cloud infrastructure 102 comprising one or more servers and databases 104. This is merely an example infrastructure however, the servers need not necessarily be cloud-based.

The cloud infrastructure 102 may for example comprise a database 104 configured to receive and store multimedia content and user data for a plurality of user accounts and a set of connected servers or nodes configured to enact the operations as disclosed herein.

The cloud infrastructure 102 is configured to communicate with a set of client devices 110 by various means over the illustrated network architecture. The illustrative client devices 110 include devices configured to communicate with the cloud infrastructure 102 via a communications tower 106. These devices may include but are not limited to a smartphone 112, a laptop 114, and a tablet computer 116.

Additional client devices configured to communicate with the cloud infrastructure 102 via a networked computer modem 108 include but are not limited to a smart display 118 and a second laptop 120. Some of the connections may be wired connections, such as the connection between the smart display 118 and the networked computer modem 108.

Any one of the client devices 110 may be operationally coupled to a wide area network (WAN) such as the Internet with a wireless connection. The wireless clients may be communicatively coupled to the WAN via a Wi-Fi (or Bluetooth) access point that is communicatively coupled to a modem, which is communicatively coupled to the WAN. The wireless clients may also be communicatively coupled to the WAN using a proprietary carrier network that includes illustrative communication tower 106.

While a specific set of client devices are illustrated in the architecture of FIG.1 the client devices may in fact be any suitable device. For example, client devices could include a mobile handset, mobile phone, wireless phone, portable cell phone, cellular phone, portable phone, a personal digital assistant (PDA), a tablet, a portable media device, a wearable computer, or any type of mobile terminal which is regularly carried by an end user and has all the elements necessary for operation in a wireless communication system. The wireless communications include, by way of example and not of limitation, CDMA, WCDMA, GSM, UMTS, or any other wireless communication system such as wireless local area network (WLAN), Wi-Fi or WiMAX.

Each client device 110 may be associated with or “logged in” to a user profile in order to operate within the disclosed system and method, and further configured to send requests, upload user data, and generally interact with the cloud infrastructure 102 via a user interface displayed on the device.

Referring to FIG.2, an example set of interfaces 200 is shown which a user logged in to a user profile 202 may have access to within the disclosed system.

In order to reach this “dashboard” the user may be required to enter a password and user identification such as an email or username, and thus be directed to an interface linked with a set of associated user data stored in database 104.

Together, the set of interfaces or “modules” which include separate areas for learning, collaboration, tournament hosting (in some examples), and business management provide options which facilitate streaming or downloading of educational multimedia content to allow a user to quickly familiarise themselves with and start an organisation in a new industry, and in some cases also facilitating competitive online play between one or more user profiles.

It is a self-contained learning platform that allows for a deep understanding of an industry without leaving the platform, meaning that once logged on, a user never has to leave to access another platform.

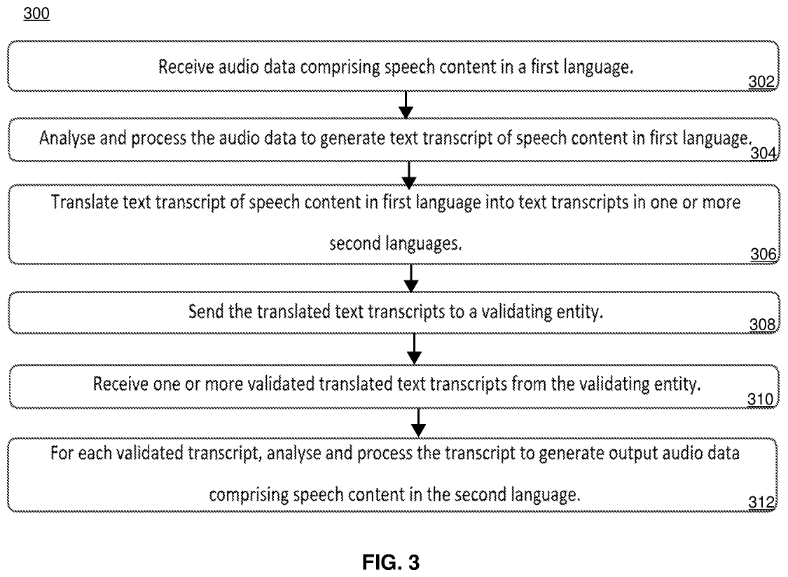

The learning interface 204 comprises proprietary course structures with quizzes, assignments, educational lectures, and various other learning options. A user can stream or download an audio or video file of an educational lecture in a variety of languages, the audio for which is automatically generated as explained below in reference to FIG.3.

The interface for learning also comprises options allowing a user to track their educational progress by accessing a learning history for their user profile from database 104 and also allows them to view a course status for relevant courses, i.e. pending, active, expired, and so on.

The user can also submit and view the status of one or more course assignments for those courses and also view their own transcripts and certificates earned for each respective educational course.

The collaboration interface 206 comprises a proprietary instant messaging service where a user may create private groups to engage with cohorts as they learn as well as in some examples an e-commerce marketplace to sell their services.

The tournament interface 208 comprises proprietary tournament-hosting software allowing users to create and participate in business-centric competitions.

This interface allows a user to create competitive gaming tournaments between one or more user profiles by specifying a tournament organizer, prizes, and a rule set for the competition.

Users may also register for participation in one or more tournaments on the platform via the interface, manage their match schedule for one or more tournaments on the platform, and accept or decline tournament enrolment invitations.

The business management interface 210 comprises proprietary software to build a micro-website and various tools for building a brand such as allowing a user to upload a brand logo and apply it to their website, as well as selecting pre-built website themes from various options stored in the user database 104.

Referring to FIG. 3, a flow diagram 300 is shown of an example method for automatically translating speech content into multiple languages for streaming to users of the disclosed system.

This novel method implemented by the servers may be beneficial if a pre-recorded lecture has only been recorded in one language but needs to be streamed to users of various nationalities that do not speak the original language.

The method may implement machine learning and artificial intelligence algorithms for natural language processing to automatically generate transcripts in the original language based on the audio and then generate new audio with translated speech in a plurality of different languages.

In the example of a sports industry, such as basketball, a famous player such as Michael Jordan may narrate a masterclass instructional video in English, with this being the original audio data based on which a plurality of translated audio files are created. In some examples, the generated audio files are overlaid on a virtual avatar of the instructor for each language it is translated into.

In a first step 302, the method involves receiving audio data comprising speech content in a first language. In the present example this would be an audio file such as an .mp3 file containing speech content of Michael Jordan speaking English in the masterclass.

In a second step 304, the method involves analysing and processing the audio data to generate text transcript of speech content in first language. For example, an AI algorithm trained on human speech transcription may generate a .txt file of the masterclass based on the original audio file.

In a third step 306, the method involves translating the text transcript of the original speech content in the first language into text transcripts in one or more second languages. For example a second AI algorithm trained in translation between a predetermined set of languages may generate multiple secondary .txt files from the first .txt file. For example from English into German, French, and Spanish. Secondary .txt files may be generated in 20 or more languages.

In a fourth step 308, the method involves sending the translated text transcripts to a validating entity. This step ensures the produced content is intelligible and allows the validating entity, who may be a human operator, to check sentence structure and contextual accuracy of the generated secondary .txt files.

In a fifth step 310, the method involves receiving one or more validated translated text transcripts from the validating entity after the sentence structure etc has been checked. Edits may have been made to the transcripts for intelligibility.

In a sixth step 312, the method involves, for each validated transcript, analysing and processing the validated secondary .txt transcripts in the multiple other languages to generate secondary output audio data files, such as new .mp3 files, comprising speech content in the second languages.

It should be understood that the operations described herein may be carried out by any processor. In particular, the operations may be carried out by, but are not limited to, one or more computing environments used to implement the method such as a data center, a cloud computing environment, a dedicated hosting environment, and/or one or more other computing environments in which one or more assets used by the method re implemented; one or more computing systems or computing entities used to implement the method; one or more virtual assets used to implement the method; one or more supervisory or control systems, such as hypervisors, or other monitoring and management systems, used to monitor and control assets and/or components; one or more communications channels for sending and receiving data used to implement the method; one or more access control systems for limiting access to various components, such as firewalls and gateways; one or more traffic and/or routing systems used to direct, control, and/or buffer, data traffic to components, such as routers and switches; one or more communications endpoint proxy systems used to buffer, process, and/or direct data traffic, such as load balancers or buffers; one or more secure communication protocols and/or endpoints used to encrypt/decrypt data, such as Secure Sockets Layer (SSL) protocols, used to implement the method; one or more databases used to store data; one or more internal or external services used to implement the method; one or more backend systems, such as backend servers or other hardware used to process data and implement the method; one or more software systems used to implement the method; and/or any other assets/components in which the method is deployed, implemented, accessed, and run, e.g., operated, as discussed herein, and/or as known in the art at the time of filing, and/or as developed after the time of filing.

As used herein, the terms “computing system”, “computing device”, and “computing entity”, include, but are not limited to, a virtual asset; a server computing system; a workstation; a desktop computing system; a mobile computing system, including, but not limited to, smart phones, portable devices, and/or devices worn or carried by a user; a database system or storage cluster; a switching system; a router; any hardware system; any communications system; any form of proxy system; a gateway system; a firewall system; a load balancing system; or any device, subsystem, or mechanism that includes components that can execute all, or part, of any one of the processes and/or operations as described herein.

As used herein, the terms computing system and computing entity, can denote, but are not limited to, systems made up of multiple: virtual assets; server computing systems; workstations; desktop computing systems; mobile computing systems; database systems or storage clusters; switching systems; routers; hardware systems; communications systems; proxy systems; gateway systems; firewall systems; load balancing systems; or any devices that can be used to perform the processes and/or operations as described herein.

As used herein, the term “computing environment” includes, but is not limited to, a logical or physical grouping of connected or networked computing systems and/or virtual assets using the same infrastructure and systems such as, but not limited to, hardware systems, software systems, and networking/communications systems. Typically, computing environments are either known environments, e.g., “trusted” environments, or unknown, e.g., “untrusted” environments. Typically, trusted computing environments are those where the assets, infrastructure, communication and networking systems, and security systems associated with the computing systems and/or virtual assets making up the trusted computing environment, are either under the control of, or known to, a party.

Unless specifically stated otherwise, as would be apparent from the above discussion, it is appreciated that throughout the above description, discussions utilizing terms such as, but not limited to, “activating”, “accessing”, “adding”, “applying”, “analyzing”, “associating”, “calculating”, “capturing”, “classifying”, “comparing”, “creating”, “defining”, “detecting”, “determining” “eliminating”, “extracting”, “forwarding”, “generating”, “identifying”, “implementing”, “obtaining”, “processing”, “providing”, “receiving”, “sending”, “storing”, “transferring”, “transforming”, “transmitting”, “using”, etc., refer to the action and process of a computing system or similar electronic device that manipulates and operates on data represented as physical (electronic) quantities within the computing system memories, resisters, caches or other information storage, transmission or display devices.

Those of skill in the art will readily recognize that the algorithms and operations presented herein are not inherently related to any particular computing system, computer architecture, computer or industry standard, or any other specific apparatus. Various general purpose systems may also be used with programs in accordance with the teaching herein, or it may prove more convenient/efficient to construct more specialized apparatuses to perform the required operations described herein. The required structure for a variety of these systems will be apparent to those of skill in the art, along with equivalent variations. In addition, the present invention is not described with reference to any particular programming language and it is appreciated that a variety of programming languages may be used to implement the teachings of the present invention as described herein, and any references to a specific language or languages are provided for illustrative purposes only and for enablement of the contemplated best mode of the invention at the time of filing.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the integrated learning platform have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. An integrated system for learning, collaboration, tournament hosting, and business management, the system comprising:
one or more client devices configured for communication over a network architecture and configured to store and view received data via one or more interfaces;
one or more database having stored thereon learning content comprising multimedia data and e-learning course modules, and user data for a plurality of user profiles, the user data comprising an e-learning history for each user profile; and
one or more servers in communication with the one or more databases and the one or more client devices, the one or more servers being configured to host an integrated learning, collaboration, tournament hosting, and business management platform comprising a set of interfaces for each function, each interface having one or more options for streaming or downloading multimedia data from the one or more databases, facilitating competitive online play between one or more user profiles, or providing an instant messaging and notification service between one or more user profiles.

2. An integrated system according to claim 1, wherein the platform interface for learning comprises options allowing a user to stream or download an audio or video file of an educational lecture.

3. An integrated system according to claim 2, wherein the one or more servers are further configured to implement a natural language processing algorithm to convert speech data from an audio or video file from the one or more databases into multiple languages, the algorithm comprising the steps of:
receiving audio data comprising speech content in a first language;
analysing and processing the audio data to generate a text transcript of the speech content in the first language;
translate the text transcript of the speech content in the first language into text transcripts in one or more second languages;
send the one or more translated text transcripts to a validating entity;
receive one or more validated translated text transcripts from the validating entity;
for each validated translated text transcript, analyse and process the transcript to generate output audio data comprising speech content in the second language of the translated transcript.

4. An integrated system according to claim 3, wherein the one or more servers are further configured to overlay the audio data over a virtual lecture animation and stream the audio data and animation to the one or more client devices as an educational video.

5. An integrated system according to claim 1, wherein the platform interface for learning comprises options allowing a user to track their educational progress by accessing a learning history for their user profile from the one or more databases and viewing a course status for relevant courses.

6. An integrated system according to claim 1, wherein the platform interface for learning comprises options allowing a user to progress and track their educational progress by submitting and viewing the status of one or more assignments.

7. An integrated system according to claim 1, wherein the platform interface for learning comprises options allowing a user to track their educational progress by viewing one or more transcripts or certificates earned for a respective educational course.

8. An integrated system according to claim 1, wherein the platform interface for collaboration comprises options allowing a user to create private groups with one or more other uses, facilitating sending and receiving instant messages and media content within the group.

9. An integrated system according to claim 1, wherein the platform interface for business management comprises options allowing a user to create and design a website.

10. An integrated system according to claim 9, wherein the business management interface further comprises options for uploading a brand logo.

11. An integrated system according to claim 9, wherein the business management interface comprises options for selecting a website them from one or more pre-built website themes stored on the one or more databases.

12. An integrated system according to claim 1, the platform interface for tournament hosting comprises options allowing a user to create competitive gaming tournaments between one or more user profiles.

13. An integrated system according to claim 12, wherein the tournament creation option requires a user to specify a tournament organizer, prize, and rule set for the competition.

14. An integrated system according to claim 1, wherein the tournament hosting interface comprises options allowing a user to register for participation in a tournament on the platform.

15. An integrated system according to claim 1, wherein the tournament hosting interface comprises options allowing a user to manage their match schedule for one or more tournaments on the platform by accessing tournament data associated with the user profile which is stored on the one or more databases.
